(19) United States
(12) Patent Application Publication
(10) Pub. No.: US 2025/0069762 A1
(43) Pub. Date: Feb. 27, 2025

(54) Tube Arrangement Around a Core

(71) Applicant: Duplicent, LLC, Santa Monica, CA (US)

(72) Inventor: Curren KRASNOFF, Santa Monica, CA (US)

(21) Appl. No.: 18/428,540

(22) Filed: Jan. 31, 2024

Related U.S. Application Data
(63) Continuation of application No. 17/560,961, filed on Dec. 23, 2021, now abandoned.
Application No. 17/560,961 is a continuation of application No. 16/414,443, filed on May 16, 2019, now abandoned.
Application No. 16/414,443 is a continuation-in-part of application No. PCT/US2017/062009, filed on Nov. 16, 2017.
(60) Provisional application No. 62/423,662, filed on Nov. 17, 2016.

(51) Int. Cl. G21B 3/00; G21B 1/11; H05H 1/04

(52) U.S. Cl. CPC G21B 3/008; G21B 1/11; H05H 1/04

(57) ABSTRACT

A system includes a core, a plurality of tubes, a plurality of gates, and a plurality of compressors. The core defines a plurality of openings. The plurality of tubes extend radially outward from the core. Each tube of the plurality of tubes includes (i) a first end interfacing with one of the plurality of openings and (ii) an opposing second end. Each gate of the plurality of gates is positioned at a respective opening of the plurality of openings of the core such that the plurality of gates are positioned to selectively prevent a backflow of liquid from the core through the plurality of openings and the first end of the plurality of tubes into the plurality of tubes. Each compressor of the plurality of compressors is associated with a respective tube of the plurality of tubes and is positioned at the opposing second end of the respective tube.

### CROSS-REFERENCE TO RELATED APPLICATION

This application is a continuation of U.S. patent application Ser. No. 17/560,961, filed Dec. 23, 2021, which is a continuation of U.S. patent application Ser. No. 16/414,443, filed May 16, 2019, which is a continuation-in-part of International Patent Application No. PCT/US2017/062009, filed on Nov. 16, 2017, which claims the benefit of priority under 35 U.S.C. § 119 to U.S. Provisional Patent Application No. 62/423,662, filed on Nov. 17, 2016, the disclosures of which are incorporated herein by reference in their entireties.

### BACKGROUND

Electrical energy is utilized throughout modern society. One of the ways through which electrical energy may be produced involves utilizing a fusion reaction. The fusion reaction may fuse a plurality of atomic nuclei into a final product. The final product may have a lower mass than the combined mass of the plurality of atomic nuclei, thus producing a net product of energy according to mass-energy equivalence theory.

### SUMMARY

Systems, methods, and apparatuses for multiple reacting systems are provided. One embodiment relates to a reacting system for performing a fusion reaction and harvesting thermal energy from the fusion reaction. The reacting system includes a reactor. The reactor includes an outer core, an inner core, and a plurality of pistons. The outer core contains liquid metal. The outer core defines a plurality of openings. The inner core contains liquid metal and defines an external surface. The external surface includes a force transferring barrier configured to separate liquid metal in the outer core from liquid metal in the inner core and a central opening configured to receive plasma. Each of the plurality of pistons is positioned within one of the plurality of openings, includes a piston head, and is configured to extend the piston head into the outer core to cause displacement of the liquid metal in the outer core. The force transferring barrier is configured to transfer force from the displacement of the liquid metal in the outer core to liquid metal in the inner core thereby causing displacement of the liquid metal in the inner core and transferring force to plasma within the central opening.

Another embodiment relates to a reacting system. The reacting system includes a reactor. The reactor includes an outer core, an inner core, and a plasma chamber. The outer core contains liquid metal. The inner core contains liquid metal and includes a flexible membrane that is configured to separate liquid metal in the outer core from liquid metal in the inner core. The plasma chamber is positioned within the inner core. The plasma chamber contains plasma and includes a second flexible membrane that is configured to separate the plasma from liquid metal in the inner core. The flexible membrane is configured to transfer displacement of liquid metal in the outer core to liquid metal in the inner core. The second flexible membrane is configured to transfer displacement of liquid metal in the inner core to plasma in the plasma chamber.

Yet another embodiment relates to a reacting system. The reacting system includes a reactor. The reactor includes an outer core, an inner core, and a plurality of pistons. The outer core contains liquid metal. The outer core defines a casing including a plurality of openings. The inner core is homocentric with the outer core. The inner core contains liquid metal and defines an external surface including a membrane that is configured to separate liquid metal in the outer core from liquid metal in the inner core and to transfer displacement of liquid metal in the outer core to liquid metal in the inner core. Each of the plurality of pistons includes a piston head that is positioned in one of the plurality of openings.

In yet another embodiment the reacting system includes a plurality of liquid metal shooting tubes positioned around a core. The plurality of liquid metal shooting tubes are configured to shoot heated liquid metal into the core to compress a plasma in the core to perform a fusion reaction. The core begins empty of liquid metal and is filled by liquid metal by the plurality of shooting tubes around the core when performing the fusion reaction. Two plasma shooting devices shoot plasma into the core before the liquid metal compresses the plasma. The fusion reaction produces thermal energy, which is then reabsorbed into the liquid metal used to compress the plasma in the core. After the fusion reaction, the heated metal is removed from reaction core to produce electricity by harvesting the thermal energy from the heated liquid metal using a generator, and the liquid metal is then recycled for further compression cycles in the reactor.

These and other features, together with the organization and manner of operation thereof, may become apparent from the following detailed description when taken in conjunction with the accompanying drawings.

### BRIEF DESCRIPTION OF THE FIGURES

FIG. 1 is a schematic view of a reacting system, according to an exemplary embodiment;

FIG. 2 is a block diagram for a process of using the reacting system shown in FIG. 1, according to an exemplary embodiment;

FIG. 3 is a schematic view of a reacting system, according to another exemplary embodiment;

FIG. 4 is a block diagram for a process of using the reacting system shown in FIG. 3, according to an exemplary embodiment;

FIG. 5 is a schematic view of a reacting system, according to an exemplary embodiment;

FIG. 6 is a schematic view of the reacting system of FIG. 5, shown including a plurality of compressor refueling tubes, according to an exemplary embodiment;

FIG. 7 is a schematic view of the reacting system of FIG. 5, shown including a plurality of centripetal rotation chambers, according to an exemplary embodiment; and

FIG. 8 is a detail schematic view of one of the centripetal rotation chambers of FIG. 7, according to an exemplary embodiment.

### DETAILED DESCRIPTION

Referring to the figures generally, systems, methods, and apparatuses for performing a fusion reaction are provided.

Energy producing reactions may occur through a fusion of a plurality of atomic nuclei, such as two deuterium (e.g., 2H, heavy hydrogen, etc.) atoms, into a final product, such as helium-4 (e.g., 4He, etc.). The plurality of atomic nuclei may include two incident reactant species, such as, by way of example only, deuterium and tritium (e.g., 3H, hydrogen-3, triton, etc.) that are each positively charged. Because of their positive charges, the reactant species are repelled by an electrostatic repulsion that may be overcome in the fusion reaction. This electrostatic repulsion, also known as a coulombic barrier, may have an energy on the order of 0.1 Megaelectron volts (MeV).

Some current fusion reactions are accomplished using magnetized target fusion systems. Typically, magnetized target fusion systems require large amounts of energy to compress plasma. For example, it is common for magnetized target fusion systems to utilize between fifty and one-hundred Megajoules of energy to compress plasma. As a result, the energy output by conventional magnetized target fusion systems is lower than the large amount energy required to operate these systems. Conventional fusion reactors may employ one core to contain a liquid metal, which is used to absorb heat from a fusion reaction and also apply pressure. However, this single core design does not efficiently capture and create energy at an optimal output because the energy needs to be absorbed and transferred throughout the entire core, and the volume of the core must be a certain volume to optimally apply pressure, thus this increased size from a single core design does not allow for maximum storage of energy because of the dissipation of energy through the full volume of the liquid metal core.

The reacting systems described herein provide various designs, including a dual core design where a smaller core functions primarily to store the thermal energy from the fusion reaction and a larger core with a primary function to transfer pressure created from the pistons to the smaller core, and a reactor with liquid metal shooting devices arranged around a single core to shoot liquid metal into the single core to compress a plasma shot into the single core. The volume of the smaller core facilitates storing and transferring the thermal energy more efficiently than with the conventional single core designs. For the duel core design, the relative size of the larger core facilitates efficiently and effectively applying pressure to the smaller core. Additionally, because the outer core does not have to store thermal energy, the outer core can be larger and, thus, even greater pressure is able to be applied to plasma than in single core designs. Further, a barrier between the outer core and the inner core may thermally insulate the inner core, thereby increasing the efficiency of the reacting system. By utilizing this dual core design, the reacting system described herein is capable of obtaining a larger net output of energy than in conventional single core designs. In reactors using liquid metal shooting devices, the same energy efficiencies may be achieved by containing the heated liquid metal to a smaller inner core than other conventional magnetized target fusion systems, while applying a greater pressure to compress the plasma, thus decreasing thermal energy dissipation by containing the liquid metal in a smaller inner core, rather than over a larger volume of liquid metal in a larger core.

The reacting systems described herein are capable of applying greater pressure and concentrated heat to magnetized toroidal plasma than conventional magnetized target fusion systems, while providing improved energy storage within the inner core. This facilitates increased frequency of catalyzing plasma atoms (e.g., deuterium, tritium, helium-3, lithium-6, lithium-7, etc.), allowing the reacting system described herein to produce a positive net energy output. In contrast with conventional fusion reactors, a reacting system described herein facilitates the expansion and contraction of a relatively large volume of liquid metal under piston firing action. Through the use of a comparatively small inner core to absorb energy and a relatively larger outer core to apply pressure, a reacting system described herein is capable of more efficiently producing electrical energy than fusion reactors today.

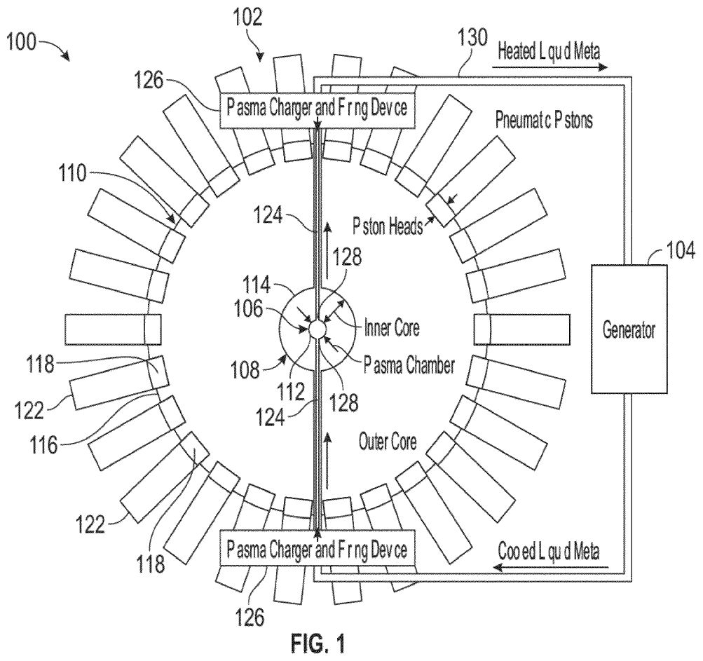

Referring to FIG. 1, a system, shown as reactor system 100, includes an apparatus, shown as reactor 102, and a generator, shown as generator 104. Reactor system 100 utilizes reactor 102 and generator 104 to produce electrical energy (e.g., electricity, etc.). Reactor system 100 may be implemented to provide electrical energy to a power grid. For example, reactor system 100 may provide electrical energy to residential, commercial, and industrial properties. Similarly, reactor system 100 may be implemented to provide electrical energy on various mobile applications, such as maritime vessels (e.g., submarines, aircraft carriers, barges, floating platforms, etc.) and for space applications (e.g., space stations, etc.).

Reactor 102 includes a first chamber, shown as plasma chamber 106, a second chamber, shown as inner core 108, and a third chamber, shown as outer core 110. In many applications, plasma chamber 106, inner core 108, and outer core 110 may be spherical in shape. According to various embodiments, inner core 108 has a diameter of between approximately 0.304 meters (e.g., one foot, etc.) and approximately 9.14 meters (e.g., thirty feet, etc.), and outer core 110 has a diameter of between approximately 0.91 (e.g., three feet, etc.) meters and approximately 60.96 meters (e.g., two-hundred feet, etc.). In other embodiments, outer core 110 has a diameter of between approximately 1.52 meters (e.g., five feet, etc.) and approximately 76.2 meters (e.g., two-hundred and fifty feet, etc.). However, other shapes (e.g., cylinder, cube, tetrahedron, hexahedron, octahedron, dodecahedron, etc.) for any of plasma chamber 106, inner core 108, and outer core 110 may be utilized. According to various embodiments, plasma chamber 106, inner core 108, and outer core 110 may be homocentric. In other words, plasma chamber 106 may be centered from every point on the exterior circumference of outer core 110. In one embodiment, plasma chamber 106 is configured to selectively hold (e.g., contain, receive, etc.) plasma (e.g., heated gas without electrons, etc.), and inner core 108 and outer core 110 are configured to hold liquid (e.g., molten, etc.) metal. Reactor system 100 creates a fusion reaction in plasma chamber 106 through shock waves (e.g., acoustic waves, vibratory waves, pressure waves, etc.) transferred through liquid metal in outer core 110 and inner core 108.

Plasma chamber 106 includes a containment surface (e.g., force transferring barrier, membrane, casing, outer surface, barrier, etc.), shown as membrane 112. Membrane 112 separates (e.g., divides, partitions, etc.) plasma chamber 106 from inner core 108 and is deformable (e.g., capable of changing shape, etc.). Similarly, inner core 108 includes a wall (e.g., force transferring barrier, membrane, casing, outer surface, barrier, etc.), shown as membrane 114.

Membrane 114 separates (e.g., divides, partitions, etc.) inner core 108 from outer core 110 and is deformable (e.g., capable of changing shape, etc.). Membrane 112 and membrane 114 are external surfaces of plasma chamber 106 and inner core 108, respectively. In an exemplary embodiment, membrane 114 insulates liquid metal in outer core 110 from liquid metal in inner core 108 while membrane 112 is relatively highly thermally conductive to facilitate heat transfer between plasma in plasma chamber 106 and liquid metal in inner core 108.

In an exemplary embodiment, membrane 112 has a relatively high thermal conductivity to facilitate energy transmission (i.e., via thermal energy) from the fusion reaction to the liquid metal in inner core 108. The liquid metal in inner core 108 is configured to absorb energy (e.g., heat, etc.) from the fusion reaction in plasma chamber 106. For example, the liquid metal in inner core 108 may be selected based on target heat transfer properties (e.g., heat capacity, thermal conductivity, etc.).

Outer core 110 includes a wall (e.g., outer surface, barrier, shell, metal containment layer, composite containment layer, lattice or patterned containment layer, selectively portioned containment layer with multiple lining materials, etc.), shown as exterior casing 116. In some embodiments, exterior casing 116 is constructed from metal (e.g., alloys, composite metals, etc.). Exterior casing 116 includes a plurality of openings (e.g., holes, bores, selectively positioned voids, etc.), shown as openings 118. Openings 118 may be equally distributed around exterior casing 116. For example, openings 118 may be distributed equidistant from one another and cover a majority of exterior casing 116. Accordingly, the number of openings 118 may be related to a spacing distance between openings 118. In other examples, openings 118 are equally spaced apart at some regions of exterior casing 116 (e.g., near a middle line of outer core 110, etc.) and more concentrated in other regions of exterior casing 116 (e.g., near a top and/or bottom of outer core 110, etc.).

Openings 118 are configured to receive piston heads, shown as piston heads 120. Piston heads 120 are configured to selectively interface with the liquid metal in outer core 110. Each of piston heads 120 is selectively driven by a piston (e.g., actuator, driver, motor, ram, rod, pneumatic device, steam device, hydraulic device, controlled heat device, fuel electric device, etc.), shown as piston 122. According to various embodiments, pistons 122 selectively drive piston heads 120 between a first position, outside of outer core 110 such that piston head 120 does not substantially extend into outer core 110, and a second position, inside outer core 110 such that piston head 120 extends into outer core 110 and displaces the liquid metal in outer core 110.

Piston heads 120 may have various shapes depending on the application of reactor system 100. For example, piston heads 120 may be generally flat, may be rounded (e.g., hemispherical, triangular, three-dimensional, patterned, etc.), or have another shape tailored to displace a maximum amount of the liquid metal in outer core 110. Piston heads 120 may have a surface area of between 92.9 square centimeters (e.g., 0.1 square feet, etc.) and 0.93 square meters (e.g., ten square feet, etc.).

Pistons 122 may be at least partially mounted (e.g., fixed, secured, attached, etc.) to outer core 110 via an interface with exterior casing 116. In some applications, reactor system 100 may include between six and five-thousand pistons 122 and the same number of piston heads 120. In other applications, reactor system 100 may include between sixteen and ten-thousand pistons 122 and the same number of piston heads 120. In some embodiments, piston heads 120 are mounted behind (e.g., relative to within the outer core 110, etc.) a metal casing or lining, where piston heads 120 may push through the lining when fired. The metal casing may isolate piston heads 120 from the liquid metal in outer core 110 when the piston heads are in the retracted second position.

Pistons 122 are configured to cause piston heads 120 to selectively enter outer core 110 and interface with the liquid metal in outer core 110 through openings 118. For example, pistons 122 may be configured to facilitate a travel of piston heads 120 into outer core 110 of between 0.03 meters (e.g., 0.1 feet, etc.) and 1.51 meters (e.g., five feet, etc.). Piston heads 120 may be configured to collectively cause a displacement of between 0.03 cubic meters (e.g., one cubic foot, etc.) and 1,132.67 cubic meters (e.g., forty-thousand cubic feet, eighty-thousand cubic feet, etc.) of liquid metal in outer core 110. In various applications, pistons 122 may be driven by compressed air, steam, pneumatic devices, hydraulically operated devices, electronically driven devices, fuel driven devices (e.g., operated by gas fuels, liquid fuels, solid fuels), and/or other working fluids. Pistons 122 may be driven at relatively high speeds such that piston heads 120 move at between, for example, ten meters per second and over one-thousand meters per second.

As piston heads 120 are driven into outer core 110, the liquid metal in outer core 110 is displaced, causing a shock wave to propagate through the liquid metal in outer core 110. In this way, the liquid metal in outer core 110 acts as a conductive medium for the shock wave. An outer core 110 of a larger volume and diameter may produce a greater focusing action on the shock wave created. The shock wave may be magnified and intensified as it travels through outer core 110 and inner core 108 through the shrinking volume of the interior of the outer core 110 and inner core 108, such as an outer core 110 of a larger diameter may produce a greater magnified shock wave, such that when the shock wave reaches the inner core the pressure applied from the shock wave is magnified, as the shock wave would otherwise be if the diameter of the outer core 110 was smaller, resulting in greater compression force applied to plasma chamber 106. In order to achieve improved magnification of the shock wave force, the liquid metal in outer core 110 and inner core 108 may be formulated to meet viscosity requirements that conduct the shock wave. When this shock wave encounters membrane 114, membrane 114 transfers the shock wave to the liquid metal in inner core 108 due to the deformable nature of membrane 114. Similar to the liquid metal in outer core 110, the liquid metal in inner core 108 acts as a conductive medium for the shock wave. As the shock wave encounters membrane 112, membrane 112 transfers the shock wave to the plasma in plasma chamber 106 due to the deformable nature of membrane 112 thereby compressing the plasma. In some embodiments, membrane 112 at least partially returns to its uncompressed state due to the shock wave reversing after the fusion reaction occurs, which facilitates more simplified firing of plasma into plasma chamber 106. Because plasma chamber 106 may be homocentric with inner core 108 and outer core 110, the shock waves from piston heads 120 encounter membrane 112 substantially simultaneously, thus leading to substantially equal compression of plasma chamber 106 from all directions and increasing the probability of a fusion reaction.

Pistons 122 are controlled (e.g., cooperatively, sequentially, etc.) to selectively drive piston heads 120 to control this shock wave. According to an exemplary operation, pistons 122 are controlled such that the shock wave produced by each piston head 120 is synchronized to selectively collapse (e.g., deform, compress, shrink, etc.) plasma chamber 106 when the plasma is in the center of plasma chamber 106. This collapse of plasma chamber 106 causes nuclei within the plasma to undergo a fusion reaction resulting in the production of energy. In various applications, reactor system 100 is capable of producing between one and one-hundred megajoules (MJ) of energy. In other applications, reactor system 100 is capable of producing between ten and fifty-thousand megawatts. In still other embodiments, reactor system 100 is capable of producing between one-thousand and fifty million MJ every twenty-four hours.

Reactor system 100 includes at least one conduit (e.g., pipe, tube, channel, etc.), shown as plasma conduit 124. Plasma conduit 124 is configured to facilitate selective transmission of plasma through outer core 110, through inner core 108, and into plasma chamber 106. In various applications, plasma conduit 124 has a length of between 1.83 meters (e.g., six feet, etc.) and 30.48 meters (e.g., one-hundred feet, etc.). According to an exemplary embodiment, plasma conduit 124 terminates on a first end at a device, shown as plasma charging and firing device 126, and terminates on a second end, opposite the first end, at plasma chamber 106. In various embodiments, reactor system 100 includes two plasma conduits 124, each including a plasma charging and firing device 126. In some embodiments, the length of the plasma conduits 124 may be short to allow for the reactor system 100 to be a miniaturized system, such that the reactor system 100 may be sized appropriately and configured for use in various transportation devices (planes, boats, aircraft, trains, trucks, cars, etc.).

According to various embodiments, plasma charging and firing device 126 is located outside of exterior casing 116. Plasma charging and firing device 126 is configured to be selectively charged with plasma and to selectively accelerate and fire the plasma into plasma chamber 106. In this way, plasma fired from two plasma charging and firing devices 126 may be propelled, each in a separate plasma conduit 124, towards plasma chamber 106. The two plasma shots fired from the two conduit 124 may have trajectories such that the two plasma shots collide within plasma chamber 106.

Plasma charging and firing device 126 is configured to fire the plasma based on timing required for the shock wave created by pistons 122 to collapse plasma chamber 106, such that the firing of the pistons 122 is adjusted based on various factors, including but not limited to, the diameter of the reactor and the distance the plasma travels. In an exemplary operation, plasma charging and firing device 126 may be configured to fire the plasma such that the plasma is in the center of plasma chamber 106 when the shock wave collapses membrane 112, thereby causing the plasma to be evenly compressed on all sides by membrane 112.

Plasma fired by plasma charging and firing device 126 may enter plasma chamber 106 at a first pressure, density, and temperature. However, after being compressed by membrane 112 in plasma chamber 106, the plasma may have a second pressure, density, and temperature. Any of the second pressure, density, and temperature may be greater than the first pressure, density, and temperature. This difference and/or these differences may be a multiple, an order of magnitude, or greater.

Plasma from plasma charging and firing device 126 enters plasma chamber 106 through openings (e.g., apertures, etc.), shown as input points 128. In an exemplary embodiment, plasma chamber 106 has two input points 128, one for each of two plasma charging and firing devices 126. In other embodiments, plasma chamber 106 has one input point 128, and one plasma charging and firing devices 126. In other applications, plasma chamber 106 includes more than two input points 128. For example, plasma chamber 106 may include two input points 128 for a single plasma charging and firing device 126. According to an exemplary embodiment, plasma chamber 106 includes two input points 128 diametrically opposed on membrane 112. However, in other embodiments, plasma chamber 106 includes two or more input points 128 otherwise angled relative to each other (e.g., angled at ninety degrees from each other, etc.). Depending on the application, plasma charging and firing device 126 may fire plasma into plasma chamber 106 at speeds up to or over 3219 kilometers per hour. In some embodiments, plasma conduit 124 is configured to radially compress the plasma as it travels towards plasma chamber 106.

In some embodiments, input points 128 are selectively reconfigurable between an open state and a closed state. For example, input points 128 may be open to receive a shot of plasma from plasma charging and firing device 126, and closed once the shot is inside of plasma chamber 106.

Reactor system 100 includes another conduit (e.g., pipe, tube, channel, etc.), shown as liquid metal circuit 130. Liquid metal circuit 130 is configured to facilitate the selective transmission of liquid metal through outer core 110 and into inner core 108 as well as from inner core 108 and through outer core 110. Liquid metal circuit 130 may include one or more conduits through which liquid metal may move from inner core 108 and through outer core 110. Liquid metal conduit 130 may protrude through outer core 110 and extend into inner core 108 at various relative orientations such as the top of outer core 110 and inner core 108, the bottom of outer core 110 and inner core 108, and other similar orientations. In one exemplary embodiment, liquid metal enters outer core 110 and inner core 108 from the top and exits inner core 108 and outer core 110 from the bottom. According to various embodiments, plasma conduit 124 is contained within (e.g., surrounded by, etc.) liquid metal circuit 130. According to other embodiments, plasma conduit 124 is parallel and separated from liquid metal circuit 130 by a small distance (e.g., 1 mm, 5 mm, 100 mm, etc.). Plasma conduit 124 may be configured to prohibit contact between plasma in plasma conduit 124 and liquid metal in liquid metal circuit 130. In some embodiments, plasma conduits 124 are connected to liquid metal circuit 130.

Generator 104 is disposed along liquid metal circuit 130. Generator 104 is configured to receive heated liquid metal, via liquid metal circuit 130, remove heat from the heated liquid metal to produce energy (e.g., via a boiler and/or turbine, etc.), and provide cooled liquid metal via liquid metal circuit 130. Generator 104 may function to harvest thermal energy from the heated liquid metal to provide electrical energy. For example, generator 104 may utilize thermal energy from the heated liquid metal to convert water into steam to drive a turbine and produce electrical energy. The temperature change in the liquid metal entering generator 104 and the liquid metal leaving generator 104 may be related to the efficiency of reactor system 100. Generator 104 may function as and/or include a pump to draw liquid metal through liquid metal circuit 130.

According to various embodiments, liquid metal is circulated in inner core 108. In some applications, liquid metal is circulated at speeds of between zero and one-thousand rotations per minute. In other embodiments, either or both of inner core 108 and plasma chamber 106 are configured to rotate independent of outer core 110, pistons 122, plasma conduit 124, plasma charging and firing device 126, liquid metal circuit 130. In other embodiments, either one of or both the liquid metal of inner core 108 and the liquid metal of outer core 110 are configured to rotate within the interior of their respective cores, where membrane 112, membrane 114, and exterior casing 116 are stationary, and the liquid metal in inner core 108 and/or outer core 110 are rotated by other means. In other embodiments, either one of or both the liquid metal of inner core 108 and the liquid metal of outer core 110 are configured to rotate within the interior of their respective cores, where membrane 112, membrane 114, and exterior casing 116 are stationary and such rotation is independent of pistons 122, and the liquid metal in inner core 108 and/or outer core 110 are rotated by other means. For example, paddles or wheels positioned within inner core 108 and/or outer core 110 may cause rotation of the liquid metal of inner core 108 and/or the liquid metal of outer core 110 independent of pistons 122.

Rotation of inner core 108 and/or outer core 110 may assist in dissipating shock waves after each compression of pistons 122. For example, inner core 108 may be configured to rotate to increase heat transfer from plasma chamber 106 to liquid metal in inner core 108. In order to rotate inner core 108 and/or outer core 110, inner core 108 and/or outer core 110 may be mounted on a rotating system such as a plasma firing device, a generator, and/or other systems. In these embodiments, plasma conduits 124 and liquid metal circuit 130 may rotate with inner core 108 and/or outer core 110. For example, inner core 108 and/or outer core 110, or only the liquid metal in inner core 108 and/or only the liquid metal in outer core 110, may rotate about plasma conduits 124 and liquid metal circuit 130. In this example, a device may be coupled to plasma conduits 124 and/or liquid metal circuit 130 that facilitates rotation of inner core 108 and/or outer core 110 without loss of liquid metal from inner core 108 and/or outer core 110. In some of these embodiments, reactor system 100 does not include membrane 112. Rather, inner core 108 is rotated to create a vortex into which plasma conduits 124 provide plasma selectively discharged from plasma charging and firing device 126. In some embodiments, plasma conduits 124 form an opening in the liquid metal in inner core 108, through which the plasma is propelled into the vortex, using a burst of air (e.g., fired in unison by plasma charging and firing devices 126). Thus, when the shock wave encounters inner core 108, the liquid metal in inner core 108 is compressed around plasma in the vortex.

In some embodiments, it is desired to alter characteristics of the plasma before it is fired into plasma chamber 106 by plasma charging and firing device 126 such that when the plasma is fired it has altered characteristics. Plasma charging and firing device 126 may, independently or cooperatively with additional plasma charging and firing devices 126, charge (e.g., create a positive charge, create a negative charge, etc.), magnetize, shape, transform, heat, cool, accelerate, and/or otherwise alter the characteristics of the plasma. Altering some characteristic(s) of the plasma may cause corresponding alterations in other characteristics of the plasma. For example, changing the shape of the plasma may cause changes in a magnetic field associated with the plasma, potentially resulting in magnetic confinement of the plasma.

In some applications, plasma charging and firing device 126 forms the plasma into a low-density, low-temperature spheromak ring. Following this example, plasma may be fired into plasma chamber 106 in a spheromak ring held together by self-generated magnetic fields. In other examples, plasma charging and firing device 126 forms the plasma into a field-reversed configuration (FRC), compact toroid, and/or other toroidal shapes.

To alter the characteristics of the plasma, plasma charging and firing device 126 may include additional components, devices, or machines, such as, for example, a magnetized coaxial gun. In some applications, plasma charging and firing device 126 is configured to heat to charge and heat the plasma. For example, plasma charging and firing device 126 may charge and heat the plasma to between five and two-hundred kiloelectron Volts (keV), inclusive. In another example, plasma charging and firing device 126 may charge and heat the plasma to between five and one-hundred keV, inclusive. By charging and heating the plasma, some of the atoms in the plasma may have energies that exceed the coulombic barrier before being fired into plasma chamber 106. In some applications, plasma charging and firing device 126 includes a fusor (e.g., Farnsworth fusor, etc.) to electrostatically confine the plasma. In other applications, plasma charging and firing device 126 includes a tokamak to magnetically confine the plasma.

In some applications, plasma charging and firing device 126 includes an acceleration device to accelerate the plasma, thus resulting in further heating and compression of the plasma. In this way, the plasma may be compressed in a higher temperature and higher density compressed toroidal plasma. The acceleration device may have a length of up to or over forty meters. The acceleration device may include an electromagnetic accelerator. In some embodiments, electrical current from the acceleration devices provides magnetic and/or electromagnetic forces on the plasma that further compress the plasma.

Depending on the application, plasma charging and firing device 126 may utilize various plasmas. In some applications, reactor system 100 utilizes any plasma having a weight of between one and two-hundred kilograms, inclusive. For example, plasma charging and firing device 126 may utilize various combinations of the plasmas of deuterium, tritium, helium-3, lithium-6, lithuium-7, and/or other plasmas. In some embodiments, the plasmas utilized in reactor system 100 have a surface that is coated in a second material such as lithium or deuteride or more coatings. This coating may reduce impurities in the plasma.

Similarly, depending on the application, reactor system 100 may utilize various types of liquid metals in inner core 108 and/or outer core 110. The liquid metal in inner core 108 and/or outer core 110 may be various combinations of molten lead-lithium. In one example, the liquid metal in inner core 108 and/or outer core 110 may be molten lead-lithium with approximately seventeen percent (e.g., by mass, by volume, etc.) lithium. In other examples, the liquid metal in inner core 108 and/or outer core 110 may be lead-lithium mixtures with other lithium percentages (e.g., zero percent, five percent, ten percent, fifteen percent, twenty percent, twenty-five percent, etc.). In one embodiment, the liquid metal in inner core 108 and/or outer core 110 is substantially pure liquid lithium and/or enriched liquid lithium. In other embodiments, the liquid metal in inner core 108 and/or outer core 110 may be one or more lithium isotopes which can absorb neutrons and/or produce tritium. In other applications, the liquid metal in inner core 108 and/or outer core 110 may include various combinations of iron, nickel, cobalt, copper, aluminum, and/or other metals or alloys thereof.

In some embodiments, the liquid metal in inner core 108 is selected to have sufficiently low neutron absorption such that a useful flux of neutrons escapes the liquid metal. In one embodiment, the liquid metal in inner core 108 is selected to have a density of approximately 11.6 grams per cubic centimeter. In one embodiment, the liquid metal in outer core 110 is selected to have a density of approximately 11.6 grams per cubic centimeter. In some embodiments, the liquid metal in inner core 108 is heated to between ten and ten-thousand keV.

In applications where reactor system 100 includes a plurality of plasma charging and firing devices 126, the plasma fired from one plasma charging and firing device 126 may differ from the plasma fired by another plasma charging and firing devices 126. For example, one plasma charging and firing device 126 may form muonic tritium from a muon and a tritium atom and fire the muonic tritium into plasma chamber 106, and another plasma charging and firing device 126 may fire deuterium into plasma chamber 106. Because the muonic tritium has a reduced Bohr radius, the columbic barrier may be reduced and helium-4 and a neutron may be produced.

According to various embodiments, membrane 112 is constructed from a deformable material that returns to its original shape when not under pressure from the compression caused by the shock wave. Membrane 112 may be flexible and may be configured to substantially evenly deform in all directions when impacted by the shock wave. Membrane 112 may be spherical, cubic, cylindrical, polygonal, tetrahedron, hexahedron, octahedron, dodecahedron, or have some other similar shape or combination thereof. In some embodiments, membrane 112 includes a number of openings to facilitate heat transfer from the fusion reaction to the liquid metal in inner core 108. For example, membrane 112 may be of a mesh construction. Membrane 112 may have various textures on the interior face (i.e., the membrane face in the direction of the fusion reaction).

According to various embodiments, membrane 114 is configured to withstand temperature of between approximate ten and one-thousand keV without deforming due to heat. Membrane 114 may be flexible and durable to withstand repeated expansion and contraction from the shock waves imparted by piston heads 120. In an exemplary embodiment, membrane 114 is constructed from a material capable of expanding and contracting at a high frequency (e.g., once every half a second, once every second, once every three seconds, etc.) while exposure to high heated liquid metal during operation of reactor system 100. Depending on the liquid metal in inner core 108, membrane 114 may have different properties. For example, if the liquid metal in inner core 108 is a lead-lithium mixture, membrane 114 may be configured to have relatively high insulating properties such that heat is retained in inner core 108.

According to various embodiments, membrane 112 has different material properties than membrane 114. Similarly, the liquid metal in outer core 110 may be different, and have different properties, than the liquid metal in inner core 108. In an exemplary embodiment, the liquid metal in outer core 110 is configured to transfer pressure from the shock wave created by piston heads 120 to inner core 108. In one embodiment, the liquid metal in outer core 110 is selected to optimize transmission (e.g., decrease losses, increase speed, etc.) of the shock wave. For example, the liquid metal in outer core 110 may have a relatively low density.

Other components of reactor system 100, such as, for example, exterior casing 116, piston heads 120, plasma conduit 124, and liquid metal circuit 130, may be constructed from various materials such as, for example, stainless steel coated with tungsten. However, these components may be constructed from other materials so long as deformation of the components is reduced or does not occur. In some embodiments, components of reactor system 100 may be subjected to temperature on the order of one-hundred keV.

According to some embodiments, plasma charging and firing device 126 is configured to fire the plasma and an auxiliary shot. The auxiliary shot may be a burst of compressed gas (e.g., air, etc.) that may function to reopen plasma chamber 106 after each shock wave. In other embodiments, the plasma discharged from plasma charging and firing device 126 may be discharged with sufficient force to reopen plasma chamber 106 independent from an auxiliary shot. Alternatively, if inner core 108 and/or outer core 110 are configured to rotate, plasma chamber 106 may at least partially reopen due to centripetal force that draws liquid metal away from plasma chamber 106 after each shock wave compression.

In one embodiment, reactor system 100 includes a suction line positioned along at least one of plasma conduit 124 and liquid metal circuit 130. The suction line may function to draw used plasma shot material from plasma chamber 106 between cycles of reactor system 100. For example, the suction line may remove used plasma shot material from plasma chamber 106 after a target number of cycles (e.g., every two cycles, every five cycles, every ten cycles, etc.). By removing used plasma shot material, reactor system 100 may obtain higher efficiencies. In some applications, the used plasma shot material may be reused (e.g., recharged, etc.) by plasma charging and firing device 126.

According to alternative embodiment, reactor system 100 does not include plasma conduit 124 or plasma chamber 106. Rather, inner core 108 and/or outer core 110 are rotated to create a vortex in the center of the liquid metal in inner core 108 and/or the liquid metal in outer core 110. Plasma is then fired directly into this vortex where it is compressed directly by the liquid metal in inner core 108. In some of these alternative applications, inner core 108 is not separated from outer core 110 by membrane 114.

In another alternative embodiment, reactor system 100 includes two plasma charging and firing devices 126 on the bottom of outer core 110 and inner core 108 but only one of the two plasma charging and firing devices 126 is contained within liquid metal circuit 130. In this embodiment, liquid metal circuit 130 additionally connects to another location in inner core 108 and/or outer core 110, such as the top.

In another alternative embodiment, liquid metal may enter and leave inner core 108 through the same location in liquid metal circuit 130. For example, a single partitioned conduit (e.g., tube, pipe, etc.) may extend through outer core 110 and into inner core 108. Following this example, liquid metal may be introduced to inner core 108 via one section of the partitioned conduit and removed from inner core 108 via another section of the partitioned conduit. This single partitioned tube may be extended through either the top or bottom of outer core 110. The single partitioned tube facilitates thermal insulation of hot liquid metal extracted from inner core 108 by the cooled liquid metal entering inner core 108.

In another alternative embodiment, reactor system 100 does not include membrane 114. Rather, the liquid metal in inner core 108 and the liquid metal in outer core 110 may contact but, due to the repulsive properties of the liquid metals, they may not mix. This allows the liquid metal of outer core 110 to insulate the liquid metal of inner core 108. In other applications where reactor system 100 does not include membrane 114, insulating metal or liquid suspension material are positioned between the liquid metal in inner core 108 and the liquid metal in outer core 110.

In yet another alternative embodiment, membrane 112 and/or membrane 114 are solid and not flexible. For example, membrane 112 and/or membrane 114 may be configured to contract (e.g., collapse, etc.) with compression from the liquid metal in outer core 110. This contraction may be facilitated by, for example, a contraction mechanism (e.g., telescoping chamber, etc.) coupled to a device (e.g., actuator, piston, etc.) disposed on or extending through exterior casing 116.

In some embodiments, plasma chamber 106 are held within inner core 108 by a mechanism other than plasma conduits 124. In some of these applications, plasma conduits 124 may be configured to retract and disconnected from input points 128. For example, plasma conduits 124 may be rapidly inserted to connect with input points 128 prior to firing plasma (e.g., within one to three seconds of firing plasma, etc.).

In some embodiments, exterior casing 116 is collapsible (e.g., able to decrease in internal volume, etc.). As exterior casing 116 collapses, exterior casing 116 substantially maintains a spherical shape (e.g., a perfect sphere, an imperfect sphere, etc.). As exterior casing 116 collapses, a shock wave (e.g., a pressure shock wave, etc.) is transferred through liquid metal in outer core 110 which is subsequently transferred to liquid metal in inner core 108 and thereby to plasma in plasma chamber 106. In this way, exterior casing 116 may expand and contract to cause compression of plasma in plasma chamber 106. In some embodiments, this configuration of exterior casing 116 eliminates the need for pistons 122 in reactor system 100. In other embodiments, pistons 122 compliment collapsing of exterior casing 116. For example, pistons 122 may further compress plasma in plasma chamber 106 after exterior casing 116 has fully collapsed.

In applications where exterior casing 116 is collapsible, exterior casing 116 may be constructed from a plurality of overlapping panels (e.g., segments, etc.) which slide together to collapse exterior casing 116. The overlapping between the panels creates a seal therebetween such that liquid metal is maintained within exterior casing 116. This seal is maintained before, after, and during collapsing of exterior casing 116. The panels may be, for example, one foot wide by four feet tall. In other examples, the panels may be one foot wide by more than four feet tall. Each of the panels may be, for example, flat, curved, or rounded (e.g., arc shaped, etc.).

Collapsing of exterior casing 116 may be also be accomplished through the use of contracting members (e.g., contracting rods, contracting beams, contracting plates, etc.) which are positioned around inner core 108. The contracting members are configured such that liquid metal in outer core 108 causes the contracting members to expand and shrink. In some applications, the contracting members may be configured such that liquid metal may only contact an interior side of the contracting members. For example, the contracting members may be positioned along an interior surface of exterior casing 116. During collapsing and expanding of exterior casing 116, liquid metal remains sealed within exterior casing 116.

It is understood that while only two plasma charging and firing devices 126 are shown in FIG. 1, reactor system 100 may incorporates three, six, ten, or more plasma charging and firing devices 126. In such applications, all plasma charging and firing devices 126 would be configured as described herein and would be positioned equidistant about exterior casing 116.

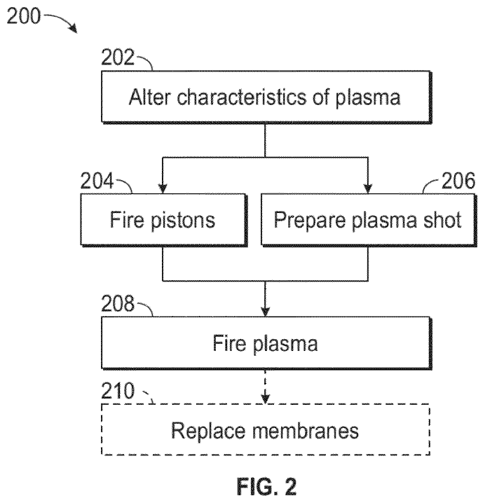

Referring to FIG. 2, reactor system 100 is controlled according to a process (e.g., operating sequence, etc.), shown as reacting process 200. Reacting process 200 may include an energy producing stage and an energy harvesting stage. Reacting process 200 causes a fusion reaction of plasma in plasma chamber 106 thereby producing thermal energy that is absorbed by liquid metal in inner core 108 and transferred via liquid metal circuit 130 to generator 104, where it is harvested to produce electrical energy. According to various embodiments, reacting process 200 occurs over a duration of between 0.1 second and five seconds, inclusive. During reacting process 200, liquid metal may be continuously pumped through liquid metal circuit 130. The reacting process employed by reactor system 100 begins (step 202) with altering characteristics of the plasma by plasma charging and firing device 126. For example, the plasma may be charged (e.g., positively, magnetically, etc.) in plasma charging and firing device 126. In some applications, reactor system 100 does not alter the characteristics of the plasma.

Reactor system 100 then (step 204) fires all pistons 122 thereby causing all piston heads 120 to simultaneously displace the liquid metal in outer core 110. Each piston 122 creates a shock wave that travels towards inner core 108. The firing of pistons 122 may be synchronized, coordinated, or otherwise cooperatively programmed such that the shock waves impact plasma chamber 106 at substantially the same time. As the pistons 122 are fired, plasma charging and firing device 126 prepares to fire plasma (step 206). Plasma charging and firing device 126 may concurrently prepare multiple shots of plasma (e.g., two, five, ten, fifty, etc.) to be sequenced and fired. This may include reusing previously fired plasma shot materials.

Reactor system 100 then fires plasma from plasma charging and firing device 126 (Step 208). In an exemplary embodiment, reactor system 100 includes two plasma charging and firing devices 126. Both of the two plasma charging and firing devices 126 simultaneously fire plasma towards plasma chamber 106. The time difference between when pistons 122 are fired (step 204) and when plasma is fired (step 208) may be between 0.2 and five seconds. The firing of plasma charging and firing devices 126 may be controlled by a processor, processing circuit, computer, or other controller. Heat from a fusion reaction in plasma chamber 106 may then be harvested as previously described, and reacting process 200 may repeat.

After a number of cycles, it may be desirable to replace membrane 112 and/or membrane 114 (step 210). For example, membrane 112 and/or membrane 114 may be removable from plasma chamber 106 and/or inner core 108, respectively. Replacing membrane 112 and/or membrane 114 may occur regularly (e.g., during maintenance cycles, etc.). By replacing membrane 112 and/or membrane 114, reactor system 100 may be reconfigured for different applications (e.g., the use of different liquid metals, different plasmas, etc.).

In some embodiments, liquid metal is not continuously pumped through liquid metal circuit 130 while a reaction is occurring and is instead only pumped through liquid metal circuit 130 after a reaction has been completed. For example, liquid metal may not be pumped through liquid metal circuit 130 during step 202, step 204, step 206, or step 208.

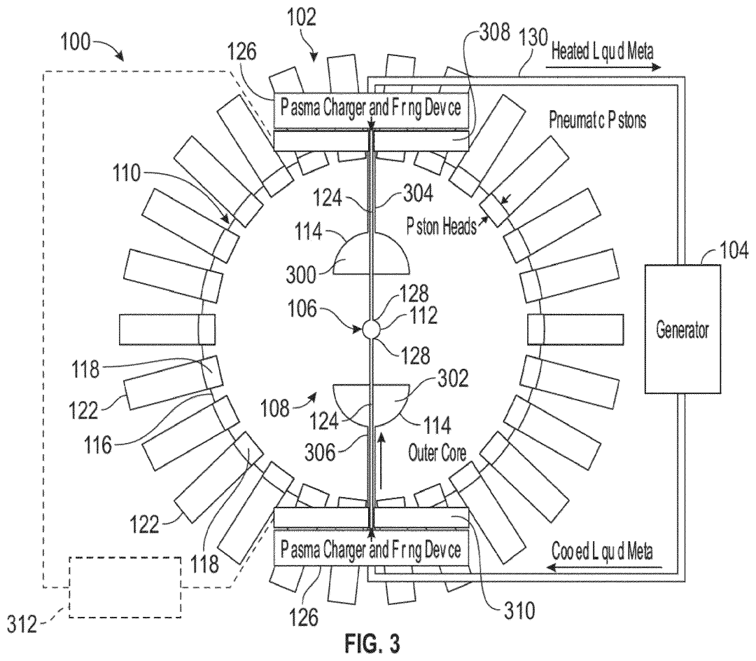

Referring to FIG. 3, reactor system 100 is shown according to another embodiment. In this embodiment, reactor system 100 is structured such that inner core 108 and membrane 114 are divided into a first half, shown as first half 300, and a second half, shown as second half 302. As shown in FIG. 3, first half 300 and second half 302 are separated. However, first half 300 and second half 302 are movable such that first half 300 and second half 302 can selectively mate to encapsulate (e.g., surround, cover, etc.) plasma chamber 106. When the first half 300 and the second half 302 are mated, plasma may be shot at a center point of each of the first half 300 and the second half 302. In this way, pressure can be applied directly (e.g., without losses due to passing through structure such as membrane 114, etc.) from outer core 110 to plasma chamber 106, when first half 300 and second half 302 are separated, and thermal energy can be harvested from within first half 300 and second half 302, when first half 300 and second half 302 are mated (e.g., after a reaction within plasma chamber 106, etc.).

In this embodiment, liquid metal circuit 130 includes a first portion, shown as a first arm 304, and a second portion, shown as a second arm 306. First arm 304 and second arm 306 are selectively repositionable within outer core 110. For example, first arm 304 and second arm 306 may be telescopic. First arm 304 is coupled to first half 300, and second arm 306 is coupled to second half 302. In this way, first arm 304 may be selectively extended or retracted to cause repositioning of first half 300 within outer core 110. Similarly, second arm 306 may be selectively extended or retracted to cause repositioning of second half 302 within outer core 110. Further, first arm 304 and second arm 306 are fluidly connected to liquid metal circuit 130 such that liquid metal may be circulated between first arm 304, second arm 306, first half 300, and second half 302 when first half 300 is mated to second half 302.

First half 300 and second half 302 may mate by insertion and/or rotation facilitated by first arm 304 and/or second arm 306. For example, first half 300 may include a plurality of posts that are received in a plurality of holes or slots in second half 302. One of first half 300 and second half 302 may be rotated relative to the other of first half 300 and second half 302 such that the posts are secured within the holes or slots. In other applications, first half 300 and second half 302 include corresponding threads such that first half 300 and second half 302 may be rotated together.

Reactor 102 includes a first mechanism, shown as a first drive 308, and a second mechanism, shown as a second drive 310. First drive 308 is configured to (e.g., is structured to, operable to, etc.) selectively extend and retract first arm 304, and second drive 310 is configured to selectively extend and retract second arm 306. First drive 308 and second drive 310 are communicable with a controller, shown as a controller 312. Controller 312 may include various processors, memories, and circuits configured to communicate with first drive 308, second drive 310, and external systems (e.g., external computers, external sensors, etc.).

In an exemplary, first half 300 and second half 302 are hemispherical. In other embodiments, first half 300 and second half 302 are conical or frustoconical. In still other embodiments, first half 300 and second half 302 are cylindrical. In various applications, first half 300 and second half 302 may be prismatic, rectangular, square, and otherwise similarly shaped.

First arm 304 and second arm 306 may be extended and retracted along plasma conduits 124, as shown in FIG. 3. In other applications, first arm 304 and second arm 306 may be extended and retracted independent of plasma conduits 124. For example, first arm 304 and second arm 306 may be offset relative to plasma conduits 124. In these applications, first drive 308, second drive 310, and liquid metal circuit 130 would be correspondingly offset.

In some applications, inner core 108 is configured to extend or retract only from a single arm (e.g., first arm 304, second arm 306, etc.). In these embodiments, inner core 108 may contain a mechanism for receiving plasma chamber 106 and subsequently sealing plasma chamber 106 within inner core 108. For example, inner core 108 may contain a closable aperture that is opened to receive plasma chamber 106. In these embodiments, liquid metal circuit 130 circulates within the arm such that liquid metal flows into the arm, into inner core 108 around plasma chamber 106, and back through the arm towards liquid metal circuit 130.

Reactor system 100 is configured such that thermal energy is harvested from first half 300 and/or second half 302. In some embodiments, reactor system 100 is configured such that thermal energy is harvested from both first half 300 and second half 302. In other embodiments, reactor system 100 is configured such that thermal energy is harvested from only one or first half 300 and second half 302.

In some embodiments, first half 300 and second half 302 are collapsible (e.g., into a more narrow form, etc.). In these embodiments, first half 300 and second half 302 may be in a collapsed state when first half 300 is not mated to second half 302, such as when first half 300 and second half 302 are moving within outer core 110. In this way, first half 300 and second half 302 may move more easily (e.g., with less force from first drive 308 and second drive 310, etc.).

In some embodiments, plasma chamber 106 are held within inner core 108 by a mechanism other than plasma conduits 124. In some of these applications, plasma conduits 124 may be configured to retract and disconnected from input points 128. For example, plasma conduits 124 may be rapidly inserted to connect with input points 128 prior to firing plasma (e.g., within one to three seconds of firing plasma, etc.). This movement of plasma conduits 124 may be facilitated by first drive 308 and second drive 310.

It is understood that while only first drive 308 and second drive 310 are shown in FIG. 3, reactor system 100 may incorporates three, six, ten, or more drives similar to first drive 308 and second drive 310 described herein. In such applications, all drives could be positioned equidistant about exterior casing 116.

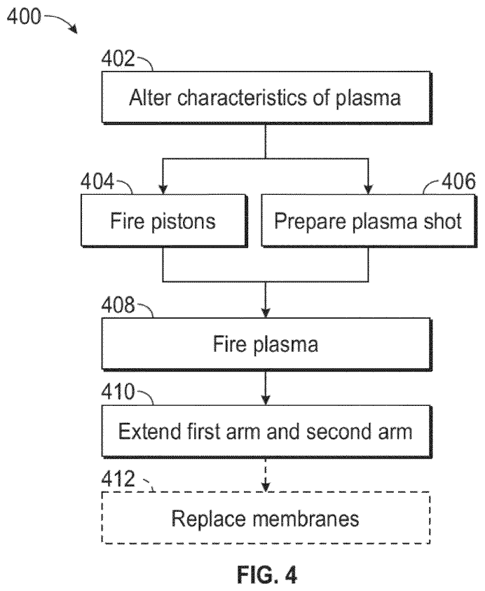

Referring to FIG. 4, reactor system 100 is controlled according to a process (e.g., operating sequence, etc.), shown as reacting process 400. Reacting process 400 is similar to reacting process 200, and includes similar steps. Reacting process 400 may include an energy producing stage and an energy harvesting stage. Reacting process 400 causes a fusion reaction of plasma in plasma chamber 106 thereby producing thermal energy that is absorbed by liquid metal in inner core 108 and transferred, after first half 300 and second half 302 have been extended to mate so as to encapsulate plasma chamber 106, via liquid metal circuit 130 to generator 104, where the thermal energy is harvested to produce electrical energy. According to various embodiments, reacting process 400 occurs over a duration of between 0.1 second and five seconds, inclusive. During reacting process 400, liquid metal may be continuously pumped through liquid metal circuit 130. For example, liquid metal may flow out of second half 302 and into first half 300 from outer core 110. The reacting process employed by reactor system 100 begins (step 402) with altering characteristics of the plasma by plasma charging and firing device 126. For example, the plasma may be charged (e.g., positively, magnetically, etc.) in plasma charging and firing device 126. In some applications, reactor system 100 does not alter the characteristics of the plasma. At this stage, first half 300 and second half 302 are in a retracted state and do not encapsulate plasma chamber 106.

Reactor system 100 then (step 404) fires all pistons 122 thereby causing all piston heads 120 to simultaneously displace the liquid metal in outer core 110. Each piston 122 creates a shock wave that travels towards plasma chamber 106. The firing of pistons 122 may be synchronized, coordinated, or otherwise cooperatively programmed such that the shock waves impact plasma chamber 106 at substantially the same time. As the pistons 122 are fired, plasma charging and firing device 126 prepares to fire plasma (step 406). Plasma charging and firing device 126 may concurrently prepare multiple shots of plasma (e.g., two, five, ten, fifty, etc.) to be sequenced and fired. This may include reusing previously fired plasma shot materials.

Reactor system 100 then fires plasma from plasma charging and firing device 126 (step 408). Both of the two plasma charging and firing devices 126 simultaneously fire plasma towards plasma chamber 106. The time difference between when pistons 122 are fired (step 404) and when plasma is fired (step 408) may be between 0.2 and five seconds. The firing of plasma charging and firing devices 126 may be controlled by a processor, processing circuit, computer, or other controller, such as the controller 312.

Heat from a fusion reaction in plasma chamber 106 may then be harvested by first extending first arm 304 and second arm 306 until first half 300 and second half 302 mate and encapsulate plasma chamber 106 (step 410). In some embodiments, the liquid metal within outer core 110 is spun at a relatively high speed prior to extending the first half 300 and the second half 302 (step 410). Such spinning may increase pressure of the liquid metal.

Once plasma chamber 106 has been encapsulated, the reaction will provide thermal energy to liquid metal within inner core 108 which has now been formed by the mating of first half 300 and second half 302. Liquid metal can then be circulated by liquid metal circuit 130 as previously described. To repeat reacting process 400, first half 300 and second half 302 are separated and retracted.

After a number of cycles, it may be desirable to replace membrane 112 and/or membrane 114 (step 412). Replacing membrane 112 and/or membrane 114 may occur regularly (e.g., during maintenance cycles, etc.). By replacing membrane 112 and/or membrane 114, reactor system 100 may be reconfigured for different applications (e.g., the use of different liquid metals, different plasmas, etc.).

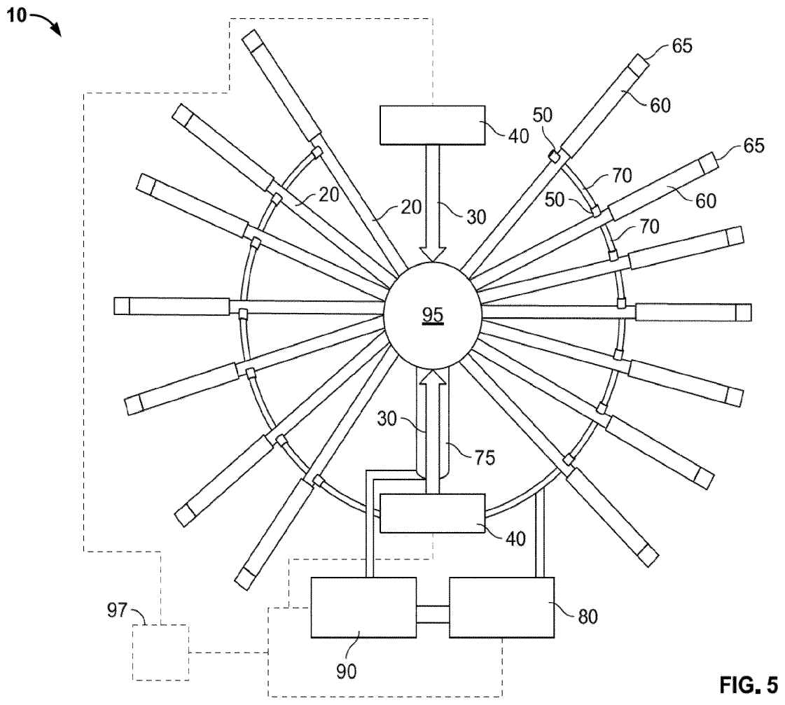

Referring to FIG. 5, reactor 10 includes a plurality of liquid metal shooting devices, shown as metal firing tubes 20 coupled to liquid metal compressors 60, configured shoot a heated liquid metal into a reaction core 95 to compress a plasma to perform a fusion reaction. In many applications, the reaction core 95 may be spherical in shape. However, other shapes (e.g., cylinder, cube, tetrahedron, hexahedron, octahedron, dodecahedron, etc.) for the reaction core 95 may be utilized.

The metal firing tubes 20 are positioned in a direction towards the reaction core 95, to allow the liquid metal in metal firing tubes 20 to shoot into the reaction core 95. Two plasma charging and firing devices 40 are positioned at opposing sides of the reaction core 95, and are configured to shoot plasma charges through corresponding plasma firing channels 30. The plasma charging and firing devices 40 and the plasma firing channels 30 are arranged such that plasma charges fired from the plasma charging and firing devices 40 meet at the center of the reaction core 95 before the liquid metal compresses the plasma. The compression of the plasma produces a fusion reaction, which produces thermal energy. This thermal energy is then reabsorbed into the liquid metal that was used to compress the plasma in the reaction core 95. After the fusion reaction, the heated metal is removed from the reaction core 95 through a heated metal extraction tube 75, and sent to a generator 90 to produce electricity by harvesting the thermal energy from the heated liquid metal. For example, the generator 90 may harvest the thermal energy from the heated liquid metal to run a turbine (or any other type of electricity generator that uses thermal energy to produce electricity) to produce electricity, which may be transferred out of the reactor 10 for various uses. The heated liquid metal is then recycled for reuse in the reaction core 95. That is, after being used to produce electricity in the generator 90, the heated liquid metal is sent to a metal storage/heater unit 80, and subsequently back into the metal firing tubes 20, through a plurality of filling tubes 70. In some instances, the plurality of filling tubes may form a spherical grid around the reaction core 95. In some embodiments, the refilling of the metal firing tubes 20 may be completed very quickly between firing sequences. For example, in some instances, the refilling process may take less than a second, less than two seconds, less than three seconds, or longer,

The metal firing tubes 20 may be fixed around the exterior surface of reaction core 95. Specifically, one end of each metal firing tube 20 may be fixed to reaction core 95. The metal firing tubes 20 may be positioned equidistantly around the exterior surface of the reaction core 95 in various arrangements. The metal firing tubes 20 may comprise or take up a substantial surface area of the exterior surface of the reaction core 95. The reactor 10 may include various quantities of the metal tiring tubes 20 (e.g. 5, 10, 15, 20, 60, 100, etc.). The metal firing tubes 20 may be positioned in various patterns around the reaction core 95 (i.e., in various grid patterns, higher densities patterns towards the top and bottom of the reaction core 95, in honeycomb patterns, etc.). The metal firing tubes 20 may be various shapes (e.g. cylinders, triangle, oval, etc.). The metal firing tubes 20 may be uniform in diameter and shape along the interior length of the component.

The metal firing tubes 20 also may provide heat from the metal firing tubes 20 directly to heat the liquid metal in the metal firing tubes 20, or preserve the temperature of the liquid metal in the metal firing tubes 20. For example, each metal firing tube 20 may be encompassed by a heater unit, similar to the storage/heater unit 80.

The liquid metal in each metal firing tubes 20 may be shot in a uniform sequence, such that the metal from all the metal firing tubes 20 is shot at the same time, and thus compresses the plasma at the same time in the reaction core 95. Said differently, metal firing tubes 20 may shoot the liquid metal at the same time in a synchronized fashion, and the liquid metal from the liquid metal firing tubes 20 may impact plasma from various directions around the plasma, thereby compressing the plasma to perform a fusion reaction. The temperature of the liquid metal upon shooting from metal firing tubes 20 may be very high to perform the fusion reaction.

As such, compressors 60 are controlled (e.g., cooperatively, sequentially, etc.) to selectively fire the liquid metal to impact the plasma. The impact of the liquid metal on the plasma causes nuclei within the plasma to undergo a fusion reaction resulting in the production of energy. In various applications, reactor 10 is capable of producing between one and one-hundred megajoules (MJ) of energy. In other applications, reactor 10 is capable of producing between ten and fifty-thousand megawatts. In still other embodiments, reactor 10 is capable of producing between one-thousand and fifty million MJ every twenty-four hours.

The metal firing tubes 20 may be filled with a heated liquid metal on various locations on the metal firing tubes 20 (i.e., the side furthest from the reaction core 95, of the metal firing tubes 20, the side of the metal firing tubes 20 through a heated metal entry point 50, etc.). In some instances, the summed volume of liquid metal contained within all of the firing tubes 20 may be the same volume as the volume of the reaction core 95. All metal firing tubes 20 on the reactor may be filled uniformly at the same time with heated liquid metal between firing sequences. The filling tube 70 may supply liquid metal to the metal entry point 50. Liquid metal may be supplied to filling tube 70 from a liquid metal storage/heater unit 80.

Similar to the reactor system 100, depending on the application, reactor 10 may utilize various types of liquid metals in the reaction core 95 and the metal firing tubes 20. The liquid metal in the reaction core 95 and/or the metal firing tubes 20 may be various combinations of molten lead-lithium. In one example, the liquid metal in reaction core 95 and/or metal firing tubes 20 may be molten lead-lithium with approximately seventeen percent (e.g., by mass, by volume, etc.) lithium. In other examples, the liquid metal in reaction core 95 and/or metal firing tubes 20 may be lead-lithium mixtures with other lithium percentages (e.g., zero percent, five percent, ten percent, fifteen percent, twenty percent, twenty-five percent, etc.). In one embodiment, the liquid metal in reaction core 95 and/or metal firing tubes 20 is substantially pure liquid lithium and/or enriched liquid lithium. In other embodiments, the liquid metal in reaction core 95 and/or metal firing tubes 20 may be one or more lithium isotopes which can absorb neutrons and/or produce tritium. In other applications, the liquid metal in reaction core 95 and/or metal firing tubes 20 may include various combinations of iron, nickel, cobalt, copper, aluminum, and/or other metals or alloys thereof.

In some embodiments, the liquid metal in reaction core 95 is selected to have sufficiently low neutron absorption such that a useful flux of neutrons escapes the liquid metal. In one embodiment, the liquid metal in reaction core 95 is selected to have a density of approximately 11.6 grams per cubic centimeter. In some embodiments, the liquid metal in reaction core 95 is heated to between ten and ten-thousand keV.

In some embodiments, compression devices, shown as metal compressors 60, may be coupled to or integrally formed with the ends of the metal firing tubes 20 located furthest away from the reaction core 95. The metal compressors 60 are configured to compress the liquid metal in the metal firing tubes 20 rapidly, at a sequenced programed time, with a piston or other type of compression device. Such compression shoots the liquid metal from the metal firing tubes 20 into the reaction core 95.

The metal compressors 60 may use compressed gas, compressed liquid, a controlled explosive, or other mechanically actuating compression configurations. In some instances, the metal compressors 60 may utilize various explosive charges to fire the liquid metal from the metal firing tubes 20. For example, a wide range of liquids, gases, gels, or solid fuels (i.e., C4, etc.) may be used to provide the explosive charges. The explosions may be exposed to the liquid metal directly or be used to fire a piston rapidly. In any case, the metal compressors 60 may rapidly displace the liquid metal in the metal firing tubes 20 pressing rapidly against the metal in metal firing tubes 20 when fired to shoot the liquid metal in metal firing tubes 20. For example, the metal compressors 60 may impact the liquid metal in the metal firing tubes 20 at a very high speed, thereby causing the liquid metal in the metal firing tubes 20 to accelerate at a high rate and reach a high speed (e.g., 50 mph, 100 mph, 150 mph, 200 mph, 500 mph, 1000 mph, 2000 mph, etc.). In some instances, the length of the firing tubes 20 may be short to maximize acceleration of the metal from the tubes. For example, if there is a larger volume of liquid metal in the firing tubes 20 (i.e., due to longer firing tubes 20), that may decrease the speed at which the metal is fired.

In some embodiments, pistons, which may be similar to the pistons 122 described above, are configured to cause corresponding piston heads, similar to the piston heads 120 described above, to selectively enter the metal firing tubes 20 and interface with the liquid metal in the metal firing tubes 20 using the compressors 60. For example, pistons may be configured to facilitate a travel of piston heads into the metal firing tubes 20 of between 0.03 meters (e.g., 0.1 feet, etc.) and 1.51 meters (e.g., five feet, etc.). Piston heads may be configured to collectively cause a displacement of between 0.03 cubic meters (e.g., one cubic foot, etc.) and 1,132.67 cubic meters (e.g., forty-thousand cubic feet, eighty-thousand cubic feet, etc.) of liquid metal in the metal firing tubes. In various applications, pistons may be driven by the compressors 60 using compressed air, steam, pneumatic devices, hydraulically operated devices, electronically driven devices, fuel driven devices (e.g., operated by gas fuels, liquid fuels, solid fuels), and/or other working fluids. Pistons may be driven at relatively high speeds such that piston heads move at between, for example, ten meters per second and over one-thousand meters per second.

The pistons, or other devices, may move at least partially into and/or through the metal firing tubes 20, (e.g., through ¼.sup.th the length of the metal firing tubes 20, ½.sup.th the length of the metal firing tubes 20, the length of the metal firing tubes 20, other lengths, etc.). The metal compressors 60 may be calibrated to supply the same compression force to each of the metal firing tubes 20, such that the liquid metal is fired at the same speed from all the metal firing tubes 20.

In some embodiments, all of the metal compressors 60 may be connected to the same compression source (i.e., air compressor, etc.), such that one main compression system supplies the force to the individual metal compressors 60 upon shooting the liquid metal. Alternatively, each metal compressor 60 may supply force individually to the liquid metal within the metal firing tubes 20. In these instances, each compressor may be refilled and reset between firing sequences, etc.

In some embodiments, where explosive charges are used to fire the liquid metal from the metal firing tubes 20, the metal compressors 60 may all be attached to charge resetting devices 65 (shown in FIG. 5). The charge resetting devices 65 may be configured to reset the charges in the metal compressors 60 quickly between firing sequences. For example, in some instances, the charge resetting devices 65 may be configured to reset the charges in less than a second, less than two seconds, less than three seconds, or longer. The metal compressors 60 may be powered using electricity. For example, the metal compressors 60 may use various mechanical actuating devices that are powered by electricity, to power a piston, etc. In some embodiments, electricity from the generator 90 may be used to power the metal compressors 60.

In some embodiments, the liquid metal may have an ideal composition for magnetism and the metal compressors 60 may be electromagnetic in nature. As such, the electromagnetic metal compressors 60 may be alternated between on and off states to fire the liquid metal. That is, the electromagnetic metal compressors 60 may suddenly and strongly repel the liquid metal disposed within the metal compressors 60 to fire the liquid metal.

In some embodiments, the ends of the liquid metal firing tubes 20 that are fixed to the reaction core 95 may be gated to prevent backflow of the heated liquid metal into the liquid metal firing tubes 2.0 during the fusion reaction. However, in some instances, the gates may remain open during the fusion reaction, as the force created by the fusion reaction may be too great for gates to withstand. In these instances, the metal firing tubes 20 may be fabricated much more strongly to withstand the forces of the fusion reaction. Further, in the instances, where the gates remain open during the fusion reaction, excess liquid metal that may re-enter the firing tubes 20 after the reaction may be pushed out of the firing tubes 20 by pistons (e.g., from the corresponding metal compressors 60) that extend all the way through the firing tubes 20, such that the liquid metal can be drained from the reactor 10.

The plasma is shot from each plasma charging and firing device 40 through both plasma firing channels 30, into the reaction core 95. For example, similar to the plasma charging and firing device 116 described above, the plasma charging and firing devices 40 may be configured to be selectively charged with plasma and to selectively accelerate and fire the plasma into the reaction core 95. In this way, plasma fired from two plasma charging and firing devices 40 may be propelled, each in a separate plasma firing channel 30, towards the reaction core 95. The two fired plasma shots may have trajectories such that the two plasma shots collide within the reaction core 95. The plasma charging and firing devices 40 may be positioned on opposite sides of reaction core 95.

Plasma fired by plasma charging and firing devices 40 may enter the reaction core 95 at a first pressure, density, and temperature. However, after being compressed by the fired in reaction core 95, the plasma may have a second pressure, density, and temperature. Any of the second pressure, density, and temperature may be greater than the first pressure, density, and temperature. This difference and/or these differences may be a multiple, an order of magnitude, or greater.

In some embodiments, it is desired to alter characteristics of the plasma before it is fired into reaction core 95 by plasma charging and firing device 40 such that when the plasma is fired it has altered characteristics. Plasma charging and firing devices 40 may, independently or cooperatively with additional plasma charging and firing devices 40, charge (e.g., create a positive charge, create a negative charge, etc.), magnetize, shape, transform, heat, cool, accelerate, and/or otherwise alter the characteristics of the plasma. Altering some characteristic(s) of the plasma may cause corresponding alterations in other characteristics of the plasma. For example, changing the shape of the plasma may cause changes in a magnetic field associated with the plasma, potentially resulting in magnetic confinement of the plasma.

In some applications, plasma charging and firing device 40 forms the plasma into a low-density, low-temperature spheromak ring. Following this example, plasma may be fired into reaction core 95 in a spheromak ring held together by self-generated magnetic fields. In other examples, plasma charging and firing device 40 forms the plasma into a field-reversed configuration (FRC), compact toroid, and/or other toroidal shapes.

Depending on the application, plasma charging and firing device 40 may utilize various plasmas. In some applications, the reactor 10 may utilize any plasma having a weight of between one and two-hundred kilograms, inclusive. For example, plasma charging and firing device 40 may utilize various combinations of the plasmas of deuterium, tritium, helium-3, lithium-6, lithuium-7, and/or other plasmas. In some embodiments, the plasmas utilized in the reactor 10 have a surface that is coated in a second material such as lithium or deuteride or more coatings. This coating may reduce impurities in the plasma.

To alter the characteristics of the plasma, plasma charging and firing device 40 may include additional components, devices, or machines, such as, for example, a magnetized coaxial gun. In some applications, the plasma charging and firing devices 40 are configured to heat to charge and heat the plasma. For example, plasma charging and firing devices 40 may charge and heat the plasma to between five and two-hundred kiloelectron Volts (keV), inclusive. In another example, plasma charging and firing devices 40 may charge and heat the plasma to between five and one-hundred keV, inclusive. By charging and heating the plasma, some of the atoms in the plasma may have energies that exceed the coulombic barrier before being fired into reaction core 95. In some applications, plasma charging and firing devices 40 include fusors (e.g., Farnsworth fusor, etc.) to electrostatically confine the plasma. In other applications, plasma charging and firing devices 40 include tokamaks to magnetically confine the plasma.

As such, both fired plasma charges may meet at the center of the reaction core 95 immediately before the liquid metal from metal firing tubes 20 compresses said plasma. A fusion reaction may occur upon the compression of the plasma in the reaction core 95 by the liquid metal shot into reaction core 95 through metal firing tubes 20. The plasma compression by the liquid metal may occur at the centermost point of the of reaction core 95. Such fusion reaction may heat the liquid metal in the reaction core 95 (i.e., the same liquid metal used to compress the plasma), thereby heating the liquid metal to a temperature greater than the starting temperature of the liquid metal used to compress plasma. The firing of the plasma from plasma charging and firing device 40 through plasma firing channel 30 into the reaction core 95 and the firing of the liquid metal from the metal firing tubes 20 may be timed such that both plasma charges reach the center of the reaction core 95 immediately before the liquid metal compresses the plasma (e.g., a few microseconds, a few nanoseconds, etc.), or at the same time. Various plasma charging and firing devices and charge fuels may be used as described above for the previously-described reactors.

The reaction core 95 may be positioned in the center of the metal firing tubes 20 and the plasma firing channels 30 to receive liquid metal from the metal firing tubes 20 and charged plasma through the plasma firing channels 30. The reaction core 95 may be a sphere, or sphere like shape. The reaction core 95 may be defined by void space within the chamber, and a single outer wall with voids formed in the wall to receive liquid heated metal, to receive plasma, and for liquid heated metal to exit. The reaction core 95 may form a seal with various connecting components to hold the liquid metal in the reaction core 95 without loss of liquid metal. The reaction core 95, may begin empty of all liquid metal before each firing sequence, such that the heated liquid metal in the reaction core 95 is drained and removed. The heated metal may be drained from the reaction core 95 quickly following the fusion reaction (i.e., in 1 second, 2, seconds, 3 seconds, 4 seconds, 5 seconds, 10 seconds, other times, etc.) through heated metal extraction tube 75 to generator 90. Extra liquid metal may be pumped into the reaction core 95 during the fusion reaction, where liquid metal is both drained from reaction core 95 and pumped into reaction core 95 through metal firing tubes 20 at the same time. Extra liquid metal may be pumped into reaction core 95 immediately following the fusion reaction to completely fill reaction core 95 with liquid metal from liquid metal firing tubes 20.

The reaction core 95 may alternatively be formed of subassemblies that form a sphere or other shape when closed and may comprise many flat or arched segments. The flat or arched segments may begin directed towards the center of the reactor 10, and the segments may then rotate to change position to form a sealed enclosure, where the segments overlap, to hold the liquid metal within the reaction core 95. The segments may be formed of many subassemblies that compress along multiple axis points along the segments. These subassemblies may overlap other subassemblies along a length segment to form an arch, such that the segments form a sphere or other curved shape when lying flat. An edge of the segments or portion of the segments may include a sealing material to better seal metal into the reaction core 95. In such embodiments, there may be a catching basin below the center of the reaction core 95 to catch excess liquid metal. This excess liquid metal may then be recycled to be reused in the reactor 10 for later cycles.

The liquid metal may be held in liquid metal storage/heater unit 80 after exiting the generator 90 before being pumped back into the metal filling tubes 70. The liquid metal storage/heater unit 80 may have a volume large enough to hold enough liquid metal to fill all of the metal firing tubes 20 to a sufficient level to perform the fusion reaction. The liquid metal storage/heater unit 80 may reheat the liquid metal to a temperature suitable for performing the fusion reaction. The storage/heater unit 80 may heat the liquid metal initially upon startup operation of the reactor 10 to a temperature suitable for performing the fusion reaction. Additionally, the storage/heater unit 80 may insulate thermal energy in the liquid metal.

In some embodiments, various liquid metal carrying tubes (e.g., metal firing tubes 20 or metal filling tubes 70) may be insulated to preserve the thermal energy of the heated liquid metal. In some instances, the storage/heater unit 80 may act solely as a storage unit, and may insulate thermal energy in the liquid metal without heating. The reactor 10 may be programmed such that the thermal energy removed from the liquid metal is removed only to a level suitable for reuse of the liquid metal for performing the fusion reaction without needing to reheat the liquid metal (i.e., accounting for lost thermal energy from the liquid metal in the generator 90). That is, the reactor 10 may be programmed such that, during holding time of the liquid metal within the liquid metal storage unit 80, liquid metal pumps, metal firing tubes 20, and other equipment, etc., the liquid metal is not cooled below a temperature that would inhibit reuse for performing a subsequent fusion reaction.

The reactor 10 may be different sizes (5 ft in diameter, 10 ft in diameter, 15 ft in diameter, 20 ft in diameter, 25 ft in diameter, sizes in between units provided, larger sizes than units provided, or smaller sizes than units provided). Various metals may be used for components which hold the liquid metal that are capable of withstanding high temperatures (i.e., the temperature of the liquid metal), as described above during the description of the previously-described reactors.

For example, various components of the reactor 10, such as, for example, metal firing tubes 20, compressors 60, metal filling tubes 70, the reaction core 95, any liquid metal pumps, and various other components of the reactor 10, may be constructed from various materials such as, for example, stainless steel coated with tungsten. However, these components may be constructed from other materials so long as deformation of the components is reduced or does not occur. In some embodiments, components of the reactor 10 may be subjected to temperature on the order of one-hundred keV.

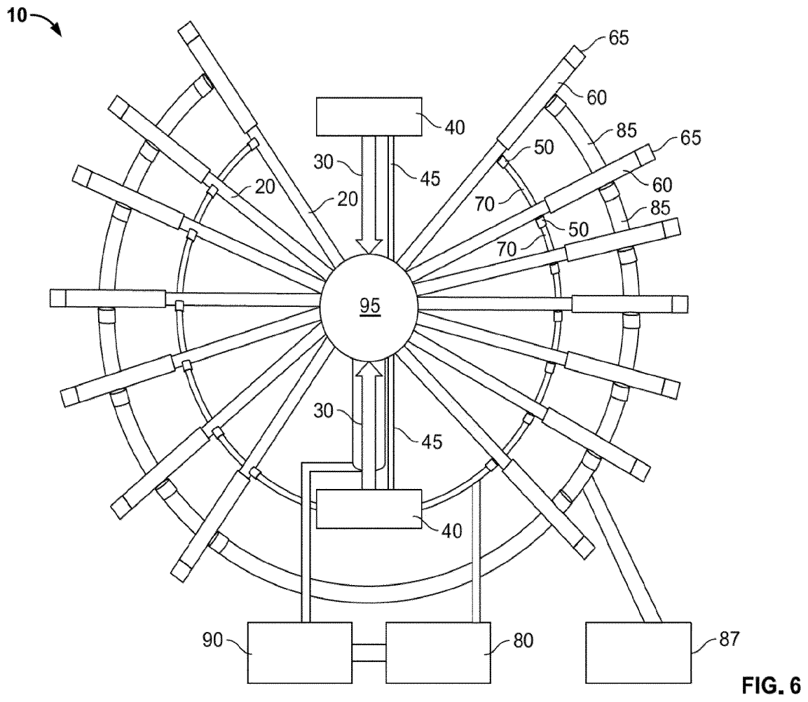

In some embodiments, the plasma charges may be recycled within the system. For example, an extraction device 45 (shown in FIG. 6) may remove the depleted plasma charge material from the reaction core 95 between or after the fusion reaction using a vacuum or other removal device, such that the plasma charge material may be recharged in either of the plasma charging and firing devices 40. Such removal may be completed quickly, for example, in less than a second, less than two seconds, less than three seconds, or more time.

In some embodiments, the used plasma charge may be removed from one side of the reactor 10, and then separated and recycled to the respective plasma charging and firing devices 40. In some other embodiments, the used plasma charge may be removed from both sides of the reactor 10, each used plasma charge removed by the respective side from which it was fired. After removal, the used plasma charge may be returned to queue in the plasma charging and firing device 40. There may be various numbers of charge materials in each plasma charging and firing device 40. For example, there may be 3, 5, 10, 15, or more charge materials.

In some embodiments, each plasma charging and firing device 40 may be provided as a separate plasma charging device and plasma firing device. In these instances, plasma materials are first charged in the plasma charging device, and subsequently sent to the firing device for firing. In some embodiments.sub.; there may be two or more plasma charging devices on each side of the reactor 10 to accelerate the firing sequence. In these embodiments, both plasma chargers may feed into the same plasma firing device, and uncharged plasma material may feed into all of the plasma chargers. The plasma chargers may alternate supplying the charged plasma for firing. In some embodiments, the plasma chargers may continue to charge the plasma up until moments before the plasma is fired, thereby minimizing any reduction of the charge of the plasma. The cycle time for the reactor 10 may be less than a second, less than two seconds, less than three seconds, or more time. The cycle time may account for the resetting of all components in the reactor 10.

In some embodiments, the reactor 10 may be provided as a miniaturized reactor. In these instances, the reaction core 95 may be small, for example, between 0.5 ft and 4 ft in diameter. Likewise, the metal firing tubes 20 may be small, for example, between 0.5 ft and 6 ft in length. The other components of the reactor 10 may be included in a space efficient package in said miniaturized embodiment. Such a space efficient package may include an input for fuel for the plasma charging. Additionally or alternatively, the plasma charges may similarly be recycled in the system. By using a miniaturized reactor, the miniaturized reactor may be sized appropriately and configured for use in various transportation devices (planes, boats, aircraft, trains, trucks, cars, etc.),

Referring briefly now to FIG. 6, the metal compressors 60 may be refilled by refueling tubes 85. The refueling tubes 85 may form a spherical grid to mirror the shape of the other components of the reactor 10 (e.g., the metal filling tubes 70). The refueling tubes 85 may be supplied fuel by a compressor fuel/charger 87.

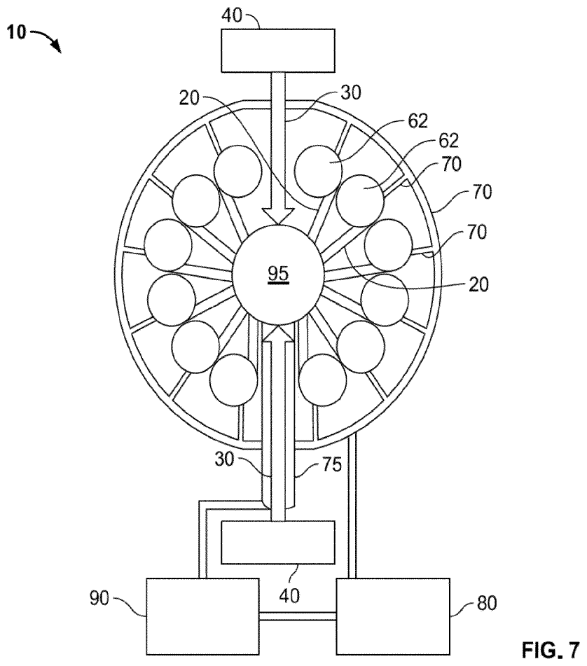

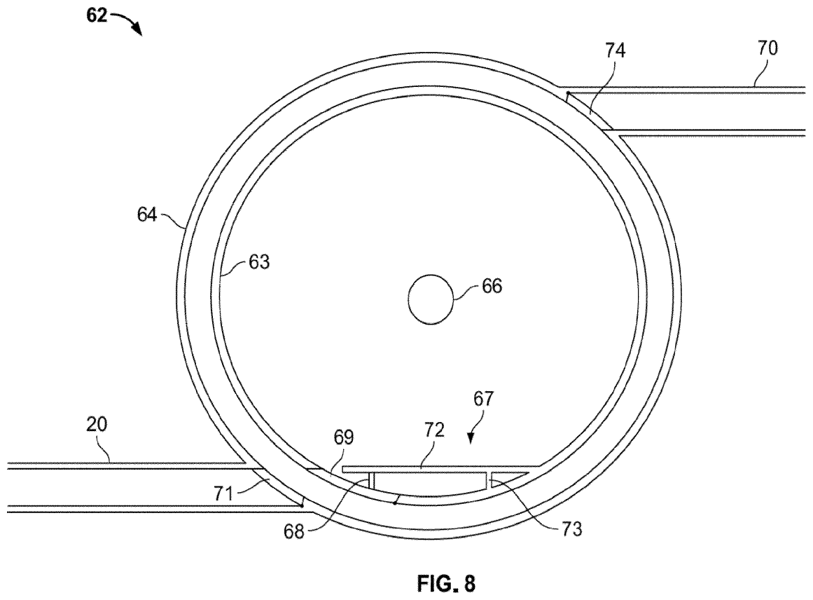

Referring now to FIGS. 7 and 8, instead of metal firing tubes, the reactor 10 may include a similar number of centripetal rotation chambers 62. The centripetal rotation chambers 62 may be fixed around the reaction core 95 to tire the liquid metal. The centripetal rotation chambers 62 may accelerate the liquid metal using centripetal mechanical action (e.g., similar to a baseball pitching machine). The centripetal rotation chambers 62 may spin the liquid metal at a very high rpm, thereby accelerating the liquid metal to a high speed. Then, the centripetal rotation chambers 62 may then be configured to release the liquid metal into the reaction core 95.

As depicted in the non-limiting and exemplary embodiment provided in FIG. 8, the centripetal rotation chambers 62 may be configured similar to a laundry machine. That is, there may be a spinning circular surface 63 disposed within a circular outer wall 64. The spinning circular surface 63 may be rotationally accelerated inside circular outer wall 64 by an accelerator 66. The liquid metal may be contained within a liquid metal securement mechanism 67 that is fixed with respect to the inner spinning circular surface 63. The liquid metal securement mechanism 67 may be configured to selectively release the liquid metal through a movable front wall 68. The spinning circular surface 63 may include an inner surface release 69 configured to open simultaneously with the movable front wall 68 of the securement mechanism 67 to send the liquid metal, through an outer wall release 71, down a metal firing tube 20 and into the reaction core 95. The outer wall release 71 may be configured to open with the movable front wall 68 of the securement mechanism 67 and the inner surface release 69. In some embodiments, the liquid metal may be fired directly into the reaction core 95. The openings of the front wall 68, the inner surface release 69 and the outer wall release 71 are in unison and extremely quick. Each of the front wall 68, the inner surface release 69 and the outer wall release 71 may be under high tension such that they can release quickly. The natural path of the centripetal force on the liquid metal sends the metal out of the chamber 62, through the metal firing tube 20, and into the reaction core 95.

The securement mechanism 67 includes the movable front wall 68, a top securing plate 72, and a back wall 73. The front wall 68 and the back wall 73 may thus separate the spinning; circular surface 63 into a smaller section to hold the liquid metal and keep the liquid metal in place as the spinning circular surface 63 rotates. In some instances, this section may be approximately 1/10.sup.th of the circumference of the spinning circular surface 63. In other instances, this section may be other sizes. The top securing plate 72 may protect or cover the liquid metal to further secure the liquid metal during rotation.

The accelerator 66 may be positioned at the center of the spinning circular surface 63, between the spinning circular surface 63 and the circular outer wall 64. Alternatively, the accelerator 66 may be located on an outer side of the spinning circular surface 63. Similarly, a second outer wall release 74 may provide an opening or entry point for the liquid metal to be provided to the centripetal rotation chamber 62 by a filling tube 70. The liquid metal may similarly be supplied through the inner surface release 69 and the movable front wall 68. Additionally, as alluded to above, gates may be fixed on the ends of the firing tubes 20 fixed to the reaction core 95 to seal the reaction core 95 after the liquid metal enters the core.

In some embodiments, all of the centripetal rotation chambers 62 may be filled with liquid metal before each firing sequence of the reactor 10. Each of the centripetal rotation chambers 62 may be further heated to preserve the temperature of the liquid metal. The centripetal rotation chambers 62 may be various sizes depending on the size of the reactor 10. There may also be many centripetal rotation chambers 62 around the reaction core 95, positioned in various three-dimensional grid arrays around the reaction core 95, similar to the tubes 70, 85. In some instances, this centripetal rotation design may reduce the cost of manufacturing the reactor 10 compared to designs using explosive charges.

In some embodiments, the electricity generated by the generator 90 may be used to power the other various systems of the reactor 10, such that the reactor 10 may be self-perpetuating, which may be especially important for miniaturized versions of the reactor. The systems that would be powered by electricity would include: the plasma charger, the plasma firing device (or the plasma charging and firing device 40), a plasma vacuum, the liquid metal storage/heater unit 80, various liquid metal pumps, and generator (e.g., for controlling operation and start processes). The electricity generated by the generator 90 may additionally be used to power a battery 97 (shown in FIG. 5) that may be used to power the various systems of the reactor 10 during the first operation on each start-up of the reactor 10.

In some embodiments, the plasma charger may be configured to recharge the plasma materials. As such, the plasma charger material may comprise a material that can temporarily hold a plasma charge. The plasma charger may additionally be conducive for holding/confining the plasma, and may comprise a material that does not lose its plasma holding properties over multiple cycles. As such, the plasma charger may be reused in many cycles, and may be conducive for magnetically confining the plasma within the charged material. Further, there may be a permanent gas or liquid that is in the plasma charger to alter the plasma formation in the plasma charger. Such liquid or gas would be selected to not degrade with repeated cycles, and the plasma may be formed through the material to alter the characteristics of the plasma. Alternatively this gas or liquid may be depleted during charging and resupplied.

Plasma charging can take 10 seconds per charge. In order to keep a fast firing rate of, e.g., one firing per second, there may be multiple plasma chargers on each side of the reactor 10. For example, there may be between 5 and 10 plasma chargers on each side of the reactor 10. The multiple plasma chargers may run in parallel. Each of the plasma chargers could be positioned in a cone (e.g., at the top of the cone), and a plasma firing device and a vacuum may be positioned at the bottom or point of the cone. The bottom opening to the cone may contain an entry point to a vacuum, and a switch may switch off the plasma firing channel and redirect airflow to the vacuum which is positioned outside of the cone by forming a temporary seal over the plasma firing channel. The vacuum may remove the plasma material. The switching of the airflow may be done between cycles quickly, less than a second, less than two seconds, or more to match the cycle time. The queue of used plasma material may be outside of the cone, or along the sides inside the cone, and the queue may feed into the top of the cone into the plasma chargers.

In some embodiments, when the reactor 10 includes the centripetal rotation chambers 62, there may be multiple rows or concentric spherical arrangements of centripetal rotation chambers 62 fixed around the reaction core 95. As such, despite acceleration of the liquid metal, in some instances, taking as long as 5 or more second, a fast firing rate of the reactor 10 may be preserved by having multiple rows being accelerated separately and simultaneously, and then being used alternately to fire the charged or accelerated liquid metal (e.g., one evenly dispersed half fires and then another evenly dispersed half fires, one evenly dispersed third fires and then another evenly dispersed third fires and then the final evenly dispersed third fires, etc.). As such, the centripetal rotation chambers 62 may maintain a fast firing rate by alternating their respective plasma firings.

In some instances, the centripetal rotation chambers 62 may instead cycle on track/circuit, such that multiple centripetal rotation chambers 62 may charge simultaneously while moving along the track/circuit, and then then centripetal rotation chambers 62 may be sequentially moved to a firing position once charged to fire plasma into the reaction core 95. For example, a track/circuit may include between 5-10 centripetal rotation chambers 62, and the reactor 10 could include multiple track/circuits disposed around the reaction core 95. Each track/circuit could define an oval shape. Alternatively, each track/circuit may define various other shapes. The firing points on the tracks/circuits may be narrow, such that there may be several circuits in close proximity around the reaction core 95. As such, the centripetal rotation chambers 62 may move through the track/circuit and charge when not in the firing position. Prior to charging, the centripetal rotation chambers 62 may be filled with liquid metal on one end. After charging, the firing of the liquid metal may occur on the other end of the centripetal rotation chambers 62. In some instances, the filling occurs immediately after firing.

Instead of a track/circuit, the centripetal rotation chambers 62 may alternatively each be movable between a charging or retracted position and a firing position. For example, each centripetal rotation chamber 62 may be moved into the charging or retracted position with several other centripetal rotation chambers 62. Then, a movement device may sequentially push the accelerated or charged centripetal rotation chambers 62 to the firing position. In some embodiments, there may be several different firing points around the reaction core 95.

Similarly, in some embodiments, when the reactor 10 includes the metal firing tubes 20 and the compressors 60, the metal firing tubes 20 and/or the compressors 60 may similarly be arranged in multiple rows or concentric spherical arrangements around the reaction core 95 to maintain a sufficiently fast firing rate of the reactor 10. That is, there may be multiple metal firing tubes 20 and/or compressors 60 charging and alternating firing to allow for a high firing rate. The metal firing tubes 20 and/or the compressors 60 may similarly be on a track/circuit, such that multiple firing tubes 20 and/or the compressors may charge while moving along the track/circuit, and then may be sequentially moved to a firing position to fire plasma into the reaction core 95.

Similarly, a track/circuit may including 5-10 metal firing tubes 20 and/or compressors 60, and the reactor 10 could include multiple track/circuits disposed around the reaction core 95. Each track/circuit may define an oval shape. Alternatively, each track/circuit may define various other shapes. The firing points on the tracks/circuits may again be narrow to allow for several circuits to be disposed in close proximity around the reaction core 95.

Further, again, instead of a track/circuit, the metal firing tubes 20 and/or the compressors 60 may each be movable between a charging or retracted position and a firing position. For example, each of the metal firing tubes 20 and/or the compressors 60 may be moved into the charging or retracted position with several other metal firing tubes 20 and/or compressors 60. Then, a movement device may push the filled or charged metal firing tubes 20 and/or compressors 60 to the firing position in a sequence. There may be several different firing points around the reaction core 95.

In some instances, the metal filling tubes 70 may be permanently fixed to the metal firing tubes 20, such that when the metal firing tubes 20 move out of the firing position, filling may start instantly after firing. In some other instances, the metal filling tubes 70 may be configured to selectively decouple and recouple to the metal firing tubes 20 to fill the metal.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the portable electronic assembly as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A system comprising:
a core defining a plurality of openings;
a plurality of tubes extending radially outward from the core, wherein each tube of the plurality of tubes includes (i) a first end interfacing with one of the plurality of openings and (ii) an opposing second end, and wherein each tube of the plurality of tubes includes a fill port positioned along an exterior thereof between the first end and the opposing second end;
a storage unit configured to store liquid, wherein the storage unit is positioned remote from the core and the plurality of tubes;
a filling grid positioned around and concentric with the core, wherein the filling grid includes a plurality of fill lines, wherein each fill line of the plurality of fill lines is fluidly coupled to the fill port of a respective tube of the plurality of tubes, and wherein the filling grid is fluidly coupled to the storage unit; and
a plurality of compressors, wherein each compressor of the plurality of compressors is associated with a respective tube of the plurality of tubes and is positioned at the opposing second end of the respective tube.

2. The system of claim 1, wherein the core and the filling grid have a spherical shape.

3. The system of claim 1, further comprising:
a compressor fuel charger; and
a fueling grid positioned around and concentric with the filling grid, wherein the fueling grid includes a plurality of fuel lines, wherein each fuel line of the plurality of fuel lines is fluidly coupled to a respective compressor of the plurality of compressors, and wherein the fueling grid is fluidly coupled to the compressor fuel charger.

4. The system of claim 3, wherein the core, the filling grid, and the fueling grid have a spherical shape.

5. The system of claim 1, wherein each tube of the plurality of tubes includes a heater configured to thermally regulate the liquid received thereby.

6. The system of claim 1, wherein the storage unit includes a heater configured to thermally regulate the liquid therein.

7. The system of claim 6, wherein at least one of the plurality of fill lines or the plurality of tubes are thermally insulated.

8. The system of claim 7, wherein the plurality of fill lines and the plurality of tubes are thermally insulated.

9. The system of claim 6, wherein the storage unit is thermally insulated.

10. The system of claim 6, wherein the heater is a first heater, and wherein each tube of the plurality of tubes includes a second heater configured to thermally regulate the liquid received thereby.

11. The system of claim 1, wherein the storage unit, the filling grid, and the plurality of tubes are thermally insulated, wherein the storage unit includes a first heater configured to thermally regulate the liquid therein, and wherein each tube of the plurality of tubes includes a second heater configured to thermally regulate the liquid received thereby.

12. The system of claim 1, further comprising a plurality of gates, wherein each gate of the plurality of gates is positioned proximate a respective opening of the plurality of openings of the core such that the plurality of gates are positioned to selectively prevent a backflow of the liquid from the core through the plurality of openings and into the plurality of tubes.

13. The system of claim 1, wherein the plurality of compressors are powered or driven by a centralized source.

14. The system of claim 1, wherein each compressor of the plurality of compressors is independently powered or driven.

15. The system of claim 1, wherein each compressor of the plurality of compressors includes a piston that translates at least partially through the respective tube associated therewith.

16. A system comprising:
a core defining a plurality of openings;
a plurality of tubes extending radially outward from the core, wherein each tube of the plurality of tubes includes (i) a first end interfacing with one of the plurality of openings and (ii) an opposing second end;
a plurality of gates, wherein each gate of the plurality of gates is positioned at a respective opening of the plurality of openings of the core such that the plurality of gates are positioned to selectively prevent a backflow of liquid from the core through the plurality of openings and the first end of the plurality of tubes into the plurality of tubes; and
a plurality of compressors, wherein each compressor of the plurality of compressors is associated with a respective tube of the plurality of tubes and is positioned at the opposing second end of the respective tube.

17. The system of claim 16, wherein each tube of the plurality of tubes includes a fill port positioned between the first end and the opposing second end thereof, further comprising a filling grid positioned around the core, wherein the filling grid includes a plurality of fill lines, wherein each fill line of the plurality of fill lines is fluidly coupled to the fill port of a respective tube of the plurality of tubes, and wherein the filling grid is configured to fluidly couple to a liquid source positioned remote from the core and the plurality of tubes.

18. The system of claim 16, further comprising a fueling grid positioned around the core, wherein the fueling grid includes a plurality of fuel lines, wherein each fuel line of the plurality of fuel lines is fluidly coupled to a respective compressor of the plurality of compressors, and wherein the fueling grid is configured to fluidly couple to a fuel source.

19. The system of claim 16, further comprising a liquid source configured to store a supply of liquid, wherein the liquid source is fluidly coupled to each tube of the plurality of tubes, and wherein the liquid source includes a heater configured to thermally regulate the supply of liquid stored therein.

20. A system comprising:
a core defining a plurality of openings;
a plurality of tubes extending radially outward from the core, wherein each tube of the plurality of tubes includes (i) a first end interfacing with one of the plurality of openings and (ii) an opposing second end, and wherein each tube of the plurality of tubes includes a fill port positioned between the first end and the opposing second end thereof;
a plurality of compressors, wherein each compressor of the plurality of compressors is associated with a respective tube of the plurality of tubes and is positioned at the opposing second end of the respective tube;
a filling grid positioned around the core, wherein the filling grid includes a plurality of fill lines, wherein each fill line of the plurality of fill lines is fluidly coupled to the fill port of a respective tube of the plurality of tubes, and wherein the filling grid is configured to fluidly couple to a liquid source positioned remote from the core and the plurality of tubes;
a fueling grid positioned around the filling grid, wherein the fueling grid includes a plurality of fuel lines, wherein each fuel line of the plurality of fuel lines is fluidly coupled to a respective compressor of the plurality of compressors, and wherein the fueling grid is configured to fluidly couple to a fuel source; and
a plurality of gates, wherein each gate of the plurality of gates is positioned at a respective opening of the plurality of openings of the core such that the plurality of gates are positioned to prevent a backflow of liquid from the core through the plurality of openings and the first end of the plurality of tubes into the plurality of tubes.
